(19) United States
(12) Patent Application Publication
(10) Pub. No.: US 2013/0166109 A1
(43) Pub. Date: Jun. 27, 2013

(54) Driver Red Light Duration Notification System

(71) Applicant: On Time Systems. Inc., Eugene, OR (US)

(72) Inventor: Matthew L. Ginsberg, Eugene, OR (US)

(73) Assignee: ON TIME SYSTEMS. INC., Eugene, OR (US)

(21) Appl. No.: 13/775,649

(22) Filed: Feb. 25, 2013

Related U.S. Application Data
(63) Continuation-in-part of application No. 13/542,938, filed on Jul. 6, 2012.
Application No. 13/542,938 is a continuation-in-part of application No. 13/352,013, filed on Jan. 17, 2012.
Application No. 13/352,013 is a continuation-in-part of application No. 12/886,100, filed on Sep. 20, 2010.
Application No. 12/886,100 is a continuation-in-part of application No. 12/821,349, filed on Jun. 23, 2010.
Application No. 12/821,349 is a continuation-in-part of application No. 12/639,770, filed on Dec. 16, 2009.
Application No. 12/639,770 is a continuation-in-part of application No. 13/425,707, filed on Mar. 21, 2012.
Application No. 13/425,707 is a continuation-in-part of application No. 11/851,953, filed on Sep. 7, 2007.
(60) Provisional application No. 61/233,123, filed on Aug. 11, 2009.

(51) Int. Cl. G08G 1/0967

(52) U.S. Cl. CPC G08G 1/0967
USPC 701/2; 701/1; 340/929

(57) ABSTRACT

A notification system determines a correspondence between a vehicle and an upcoming traffic signal, and predicts a likely remaining duration of the traffic signal in a particular state, such as “red light”, when the vehicle is at the signal's location. The notification is displayed on a user device in the vehicle, or is used to control the vehicle directly, for instance to turn off the vehicle's engine if the light is to remain red for a duration exceeding a threshold. Prediction of the vehicle's arrival is also used to set the state of the traffic signal to “vehicle waiting.”

### RELATED APPLICATIONS

This application is a continuation in part of co-pending U.S. patent application Ser. No. 13/542,938, filed Jul. 6, 2012, entitled “Driver Safety Enhancement Using Intelligent Traffic Signals and GPS”, which is a continuation in part of co-pending U.S. patent application Ser. No. 13/352,013, filed Jan. 17, 2012, entitled “Driver Safety Enhancement Using Intelligent Traffic Signals and GPS”, which is a continuation in part of co-pending U.S. patent application Ser. No. 12/886,100, filed Sep. 20, 2010, entitled “Driver Safety System Using Machine Learning”, which is a continuation in part of U.S. patent application Ser. No. 12/821,349, filed Jun. 23, 2010, entitled “Traffic Routing Display System”, which is a continuation in part of U.S. patent application Ser. No. 12/639,770, filed Dec. 16, 2009, entitled “Traffic Routing Using Intelligent Traffic Signals, GPS And Mobile Data Devices” which claims priority pursuant to 35 U.S.C. §120 upon U.S. Provisional Patent Application No. 61/233,123 filed Aug. 11, 2009, all of which are incorporated herein by reference as if fully set forth herein. This application is also a continuation in part of co-pending U.S. patent application Ser. No. 13/425,707, filed Mar. 21, 2012, entitled “System and Method for Automated Updating of Map Information”, which is a continuation in part of co-pending U.S. patent application Ser. No. 11/851,953, filed Sep. 7, 2007, entitled “System and Method for Automated Updating of Map Information”, both of which are incorporated herein by reference as if fully set forth herein.

### FIELD OF INVENTION

The present invention relates generally to traffic control, routing and safety systems.

### BACKGROUND

Significant reductions in vehicle emissions can be achieved, congestion can be limited, safety can be enhanced and travel times reduced by integrating diverse technology in the vehicular transportation domain. Numerous schemes have been proposed in the past for informing drivers of traffic conditions and presenting them with proposed alternatives when congestion is found. For example, traffic helicopters have been used for decades by radio stations to spot areas of congestion and suggest alternate paths that drivers may wish to consider.

With the growing popularity of GPS and hand-held computing devices, particularly those connected to cellular networks or the internet, other approaches have been used, such as graphical representations of maps with routes being color-coded to indicate levels of congestion.

Another approach to the traffic congestion problem involves “smart” traffic signals. For instance, railroad crossings have for decades been tied to traffic signals to help ease the flow of traffic on routes adjacent to railroad crossings when a train approaches. Further, certain systems have been installed that allow emergency vehicles such as fire trucks to change the state of a light from red to green so that the emergency vehicle can cross the intersection quickly with, rather than against, the signal.

In still another related area, various attempts have been made to collect traffic information from drivers who have, for example, GPS-enabled smartphones with them in their vehicles. Typically, such drivers do not find sufficient incentive to start up, and keep running, an application that will transmit their speed and location information to a remote traffic database.

Systems are emerging that take advantage of the integration of technologies that are available to report traffic information to drivers and suggest routes based on that information, to communicate with traffic signals, and to collect traffic information from drivers. For example, a project known as the Cooperative Intersection Collision Avoidance system for Violations (CICAS-V) sought to predict stop sign and traffic signal violations and warn the driver of the impending problem. See, e.g., Cooperative Intersection Collision Avoidance System for Violations (CICAS-V) for Avoidance of Violation-Based Intersection Crashes, Michael Maile and Luca Delgrossi (Mercedes-Benz Research & Development North America, Inc.), Paper Number 09-0118, downloaded from http://www-nrd.nhtsa.dot.gov/pdf/esv/esv21/09-0118.pdf for an exemplary research report from this project. As a follow-up to that work, research has been conducted into optimal timing for prediction of such intersection violations and for issuing warnings relating to same. See, e.g., Behavior Classification Algorithms at Intersections and Validation using Naturalistic Data, George Aoude, Vishnu Desaraju, Lauren Stephens and Jonathan How (Massachusetts Institute of Technology), presented at Intelligent Vehicles Symposium, June 2011 and downloaded from http://acl.mit.edu/papers/IV11AoudeDesarajuLaurensHow.pdf. These approaches are helpful, but rely on a level of direct communication among various infrastructure elements (traffic signals, vehicles, pedestrians) that may not be available for a number of years at many intersections.

In one particular area addressed by this disclosure, it would be advantageous to provide a system that notifies a driver as to how long a red traffic light currently controlling the vehicle's movement will remain red. It would also be advantageous to directly control vehicle operations based on such notification, for instance shutting a vehicle's engine if a red light duration is expected to exceed some threshold. It would further be advantageous to update a traffic light's state to indicate “vehicle waiting” when it is evident, based on communications with a vehicle, that the vehicle will be arriving at the traffic light while it is in a red state.

### SUMMARY OF THE DISCLOSURE

A notification system includes a system for determining when a driver is stopped at a red light and for providing a notification of the expected duration of that red light. In one aspect, the notification is presented in the driver's vehicle using a display system on a user device, such that the driver can see the expected duration of the red light and act accordingly. The display system is used in conjunction with a routing system providing communications among vehicles and traffic controls, such as traffic lights, via the Internet. In another aspect, automatic vehicle control steps are taken when a red light duration longer than a threshold time is predicted. In yet another aspect, when a correspondence between the vehicle and the traffic control is determined (i.e., when it is predicted that the vehicle will arrive at the traffic control), the system sets the traffic control to be in a “vehicle waiting” state that would otherwise only be set when the vehicle trips the in-pavement sensors adjacent to the traffic control. Other aspects are also disclosed herein.

### BRIEF DESCRIPTION OF THE DRAWINGS

FIG. 1 is a high-level block diagram of the computing environment in accordance with an embodiment described herein.

FIG. 2 is a block diagram of a user device, in accordance with an embodiment described herein.

FIG. 3 is a block diagram of a traffic signal, in accordance with an embodiment described herein.

FIG. 4 is a block diagram of a controller, in accordance with an embodiment described herein.

FIG. 5 is a block diagram illustrating an example of a computer for use as a user device, a traffic signal, or a controller, in accordance with an embodiment described herein.

FIG. 6 is a flow chart illustrating a method of providing improved traffic routing, in accordance with an embodiment described herein.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

Embodiments of the present invention provide systems, methods, and computer-readable storage media that use location-based technologies such as GPS or cellular to provide improved traffic control, human safety and driver convenience. Drivers are equipped with user devices that report duration of a traffic signal state, e.g., a red light.

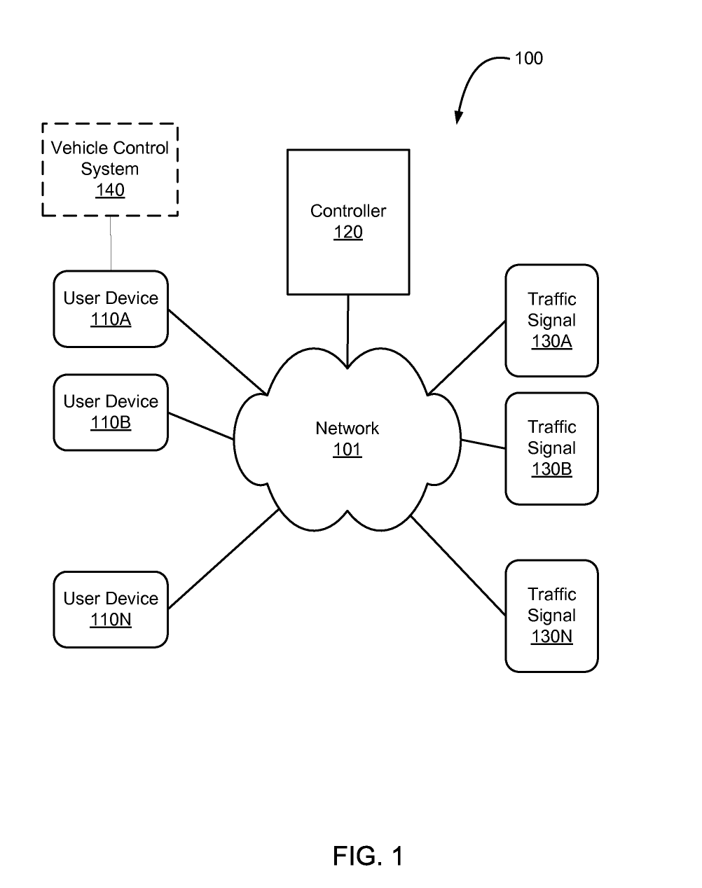

FIG. 1 is an illustration of a system 100 in accordance with one embodiment of a notification system. The system 100 includes a plurality of user devices 110A-N, that are coupled to a network 101. In various embodiments, user devices 110 may include a computer terminal, a personal digital assistant (PDA), a wireless telephone, an on-vehicle computer, or various other user devices capable of connecting to the network 101. In various embodiments, the communications network 101 is a local area network (LAN), a wide area network (WAN), a wireless network, an intranet, or the Internet, for example. In one specific embodiment, user device 110 is an iPhone® device provided by Apple, Inc. and programmed with a user-downloadable application providing one or more of the functions described herein.

The system 100 also includes a plurality of traffic signals 130A-N that are connected to the network 101 and at least one controller 120. In one embodiment, the traffic signals 130A-N are all the traffic signals for all the controlled intersections in a local area. In one implementation, the controller 120 controls the operation of all the traffic signals 130A-N in the system. Alternatively, one controller 120 may control a subset of all the traffic signals 130A-N, and other controllers may control a portion or all of the remaining traffic signals. In still another embodiment, system 100 does not control any traffic lights. In some embodiments, a user device, e.g., 110A, further interfaces with a vehicle control system 140, such as via a Bluetooth or wired connection, to control aspects of vehicle operation as described herein.

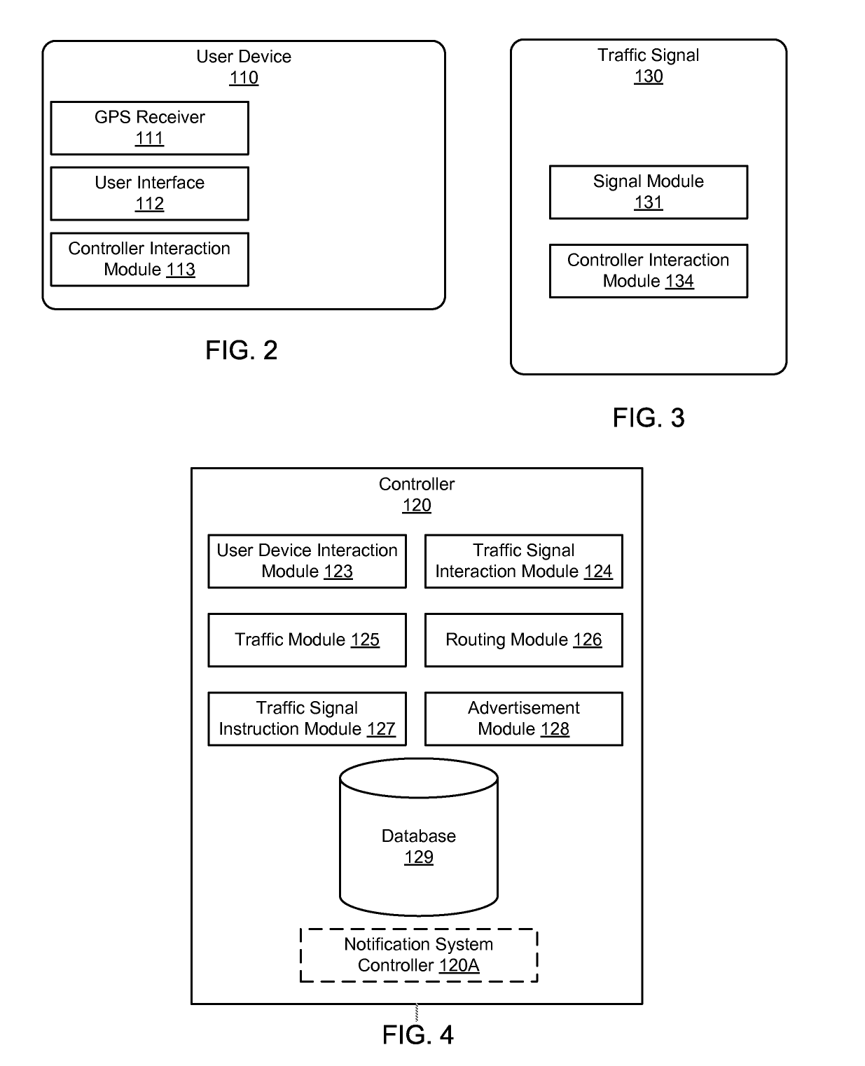

FIG. 2 is a block diagram of a user device 110, in accordance with an embodiment of the invention. In one embodiment, one user device (e.g., 110A) is in the vehicle with the driver when in operation in the system 100, and another user device (e.g., 110B) is in another vehicle. In one embodiment, each user device 110 includes a GPS receiver 111, a user interface 112, and a controller interaction module 113.

The GPS receiver 111 of the user device 110 functions to identify a precise location of the user device 110 from GPS satellite system signals received at the user device 110. Suitable GPS receivers are commonly found in handheld computing devices such as cell phones, on-board navigation systems, and other electronics. The GPS receiver 111 determines the location of the user device 110 for communication to the controller 120. Alternatively, cellular signals or other known location-determining technologies may be used to determine the position of the user device 110. For clarity, the location is discussed herein as having been determined from GPS signals although GPS signals, cellular signals or other technologies can be used in alternate embodiments.

The user interface 112 of the user device 110, discussed in greater detail below with respect to FIGS. 7-9, allows the user to input information into the user device 110 and displays information to the user. For example, the user may input a desired destination into the user interface 112 of the user device 110. The user interface 112 may display directions or a route to travel to arrive at the desired destination. The user interface 112 may also display other information relevant to the driver derived from the GPS signals received by the GPS receiver 111, received from the controller 120, or from other sources, such as current rate of speed, upcoming traffic signals, the light status of such traffic signals, and the like.

The controller interaction module 113 of the user device 110 manages the communication between the user device 110 and the controller 120. Specifically, the controller interaction module 113 sends the location information determined by the GPS receiver 111 to the controller 120 and receives the controller's messages to the user device 110 regarding traffic, navigation routes, traffic signals, and the like. As detailed below, the functions of controller 120 may in actuality be spread among multiple controller devices, for instance one under the authority of a municipality and another under the authority of a private company.

FIG. 3 is a block diagram of a traffic signal 130, in accordance with an embodiment of a routing system. The traffic signal 130 includes a signal module 131 and a controller interaction module 134.

The signal module 131 processes instructions to turn the traffic signal lights off and on and processes instructions regarding the timing of the light cycles (e.g., from green to red back to green, or in other cases from green to yellow to red and back to green). The signal module 131 may be programmed with a set of default rules for timing of the light cycles based on time of day, day of week, etc. In one embodiment, these default rules are subject to change based on instructions received from the controller 120. In other embodiments, the controller 120 instructs the signal module 131 of the traffic signal 130 with respect to every change in status of the light. In yet another embodiment, the controller 120 does not influence the operation of the traffic signal.

The controller interaction module 134 of the traffic signal 130 manages the communication between the controller 120 and the traffic signal 130. Specifically, in one embodiment, the controller interaction module 134 receives the instructions from the controller 120 and passes them to the signal module 131 for controlling the status of the light. (In another embodiment, the controller 120 does not send instructions for controlling the status of the light.) In some embodiments, the controller interaction module 134 sends a report to the controller 120 on the updated status of the lights of the traffic signal 130.

FIG. 4 is a block diagram of a controller 120, in accordance with an embodiment of the routing system. The controller includes a user device interaction module 123, a traffic signal interaction module 124, a traffic module 125, a routing module 126, a traffic signal instruction module 127, an advertisement module 128 and a database 129.

The user device interaction module 123 of the controller 120 manages the communication with the user device 110 from the controller's side. The user device interaction module 123 receives location information and optionally destination information from the controller interaction modules 113 of the user devices 110 and sends traffic, routing, or traffic signal related information to the user devices 110 via the user device interaction module 123. Likewise, the traffic signal interaction module 124 of the controller manages the communication with the traffic signal 130 from the controller's side. The traffic signal interaction module 124 may send instructions to the traffic signals 130 and may receive status updates regarding the status of the lights of the traffic signals 130 in various embodiments.

The traffic module 125 receives the location information identifying the location and, in some embodiments speed, of the user devices 110 from the user device interaction modules 123 and stores the information in a database 129. The traffic module 125 may also store information regarding traffic conditions from other sources such as other users with user devices 110, traffic services, news reports, and the like. The traffic module 125 may also receive data regarding events likely to influence traffic such as construction projects, emergency vehicle activity, and the like. The traffic module analyzes the received traffic data to determine current and in some embodiments predicted future traffic conditions and vehicle locations, and the traffic module 125 may report traffic conditions through the user device interaction module 123 to the user devices 110.

The routing module 126 combines the information communicated to the controller 120 about the locations of the user devices 110 and optionally their destinations with the traffic conditions assessed by the traffic module 125 to prepare routing instructions for the user devices 110. In some embodiments the assessment includes observed traffic conditions, predictive analysis, or both. The routing module 126 may also consider the status and timing of the traffic signals 130 to recommend routes and speeds that result in less time for drivers spent waiting at red lights or that are otherwise advantageous, as well as to provide predicted speeds for all or part of a recommended route. In some embodiments, the routing module 126 further predicts location of a vehicle at some future time based on current location, speed/direction, recommended route, historical travel of that vehicle, and the like.

In embodiments in which the controller 120 influences traffic signals, the traffic signal instruction module 127 combines information communicated to the controller 120 about the locations of the user devices 110 and optionally their destinations with the traffic conditions assessed by the traffic module 125 to prepare instructions regarding when to turn lights off and on and the appropriate timing for the cycle of lights. The traffic signal instruction module 127 may be programmed with a set of rules regarding constraints. For example, emergency responder vehicles may be given priority to reach their destinations without interruption by stoplights. Further constraints may include a maximum limit to the time length of a light, the maximum number of cars waiting for a light to change, the relative timing or synchronization between lights, and so forth. In one embodiment yet another constraint is presence of one or more other vehicles being routed and tracked by the system 100. For example, it may be known that a tracked vehicle will trigger a light's proximity sensor and cause it to cycle, because the system 100 is routing the vehicle on a known path and is aware of the vehicle's position. In some embodiments, the ability of system 100 to predict that a vehicle will arrive at a light allows the status of the traffic light to be updated (e.g., set to “vehicle waiting”) far earlier than possible using conventional in-ground inductive loop sensors.

The advertisement module 128 is included in certain embodiments to present the user with advertising related to a route request. For example, if routing module 126 has determined a route that passes nearby to an advertiser, advertisement module 128 is configured to present an advertisement, such as a coupon, to the user. In one embodiment, advertisement module 128 is configured to detect a destination request from the user that is related to an advertiser, because the advertiser has specifically requested activation upon that destination request (e.g., entry of a competitor's destination) or because the advertiser has requested activation upon any destination request of a particular type (e.g., electronics store). In still another embodiment, mere proximity of a route to a sponsored location triggers an advertisement. Once it is determined that a requested destination relates to an advertiser by one of these mechanisms, advertisement module 128 generates an appropriate coupon or other advertisement for display on user device 110.

Advertisement module 128 is configured in certain embodiments to provide information about an advertiser to a user even in circumstances where the advertiser's location and the requested destination are in dissimilar directions. In some instances, the advertiser's location may be in another direction but closer or quicker in driving time than the originally requested destination. In other instances, the information about an advertiser (such as a discount coupon) may provide an incentive for a user to go to that advertiser's location even if it is not closer or quicker.

If the user originally selected an advertiser's location as a destination, it may still be appropriate to provide the user with a coupon or other information about that advertiser, for instance to ensure that the user actually decides to go to that location or to encourage the user to make additional purchases from the advertiser.

In some embodiments, in addition to or instead of an advertisement, other relevant information is generated for display on user device 110. For example, should a user input a destination location corresponding to a retail store and that store will be closed at the estimated arrival time (as determined by review of the store's web site or as populated in a database of such information), a message warning the user that the store will be closed is displayed on user device 110 and the user is asked to verify whether that destination is still desired. In some embodiments, an alternate proposed destination (i.e., a store that will not be closed) is suggested to the user via display on user device 110 as well.

A single database 129 is shown in FIG. 4 as internal to the controller 120, however in other embodiments, the database 129 may comprise a plurality of data stores, some or all of which may reside remotely from the controller 120. For example, the data stores may be elsewhere on the network 101 as long as they are in communication with the controller 120. The database 129 is used to store user device locations, traffic conditions, alternative navigation routes and maps, traffic signal information including locations and traffic signal instructions, and any other data used by the controller for purposes such as analysis or communication with user devices 110 or the traffic signals 130.

In certain embodiments, the mere fact that a vehicle is predicted to be approaching a traffic signal is used to distinguish one state of a traffic signal from others. As an example, consider a vehicle approaching a red light. The light may currently be in a state, “Red-no vehicle waiting” but, when the vehicle arrives, the light may transition to a “Red-vehicle waiting” state. In typical implementations, the behavior of the light may be quite different depending on which of those two states it is in. In the no vehicle waiting state, the cycle time may be set for one minute, while in the vehicle waiting state, it may be set for ten seconds. Thus, in certain embodiments current state information is modified to make a more accurate prediction (e.g., an indication of a “Red-no vehicle waiting” state is interpreted as really meaning that the state, upon arrival of the vehicle, will be “Red-vehicle waiting”).

In some embodiments, other vehicle management processing is undertaken based on knowledge or prediction of a light being in or transitioning to a “vehicle waiting” or “no vehicle waiting” state, for example changing a predicted waiting time or a route for the vehicle because, even though historical red light durations at this particular light are often on the order of a minute, it is recognized that when vehicles are waiting the light transitions to green within ten seconds.

It should be noted that several possibilities exist regarding knowledge of a traffic signal's state. In some environments, the traffic signal may publish not only the current color it is displaying, but other data that is usable as described herein, such as whether the signal is in a “vehicle waiting” state or a “no vehicle waiting” state in each of the directions and lanes under its control, as well as when it entered that state and, in some instances, when it is expected to transition to the next state. This information, if available, is usable to make the determinations as described herein. Many municipal traffic signal systems, however, do not publish all of this data for each traffic signal. Some may publish information about the current color of light being shown only, while others may publish that data along with “vehicle waiting” state data, but not expected time to transition data. Still others may not publish any state information whatsoever. As described herein, available data is used directly, while information that is not available directly is inferred to the greatest extent possible.

For example, where data is not published but predictions regarding other vehicles can be made (either based on real time or historical observations), this information is likewise used to more accurately predict duration of a state of a traffic signal. To give a specific example of this, consider a first vehicle at a red light waiting for it to turn green. If there is a second vehicle in the oncoming direction that is predicted to arrive shortly in the left turn only lane, the imminent presence of such vehicle may result in a change of the state of the light from “Red-No oncoming traffic awaiting green left turn arrow” to “Red-oncoming traffic awaiting green left turn arrow”. Again, the cycle times may be dramatically different, since in the former case there is no need to wait for a left-turn arrow signal cycle for the oncoming traffic. Thus, predictions regarding the second vehicle are used in such embodiments to provide red light duration predictions for the first vehicle that are more accurate than would otherwise be possible. The example just provided is based on real-time data regarding the other vehicle, but meaningful predictions are also made in some embodiments based merely on historical information (e.g., at 5:15 p.m. on a weekday, it is observed that 78% of the time, when a vehicle arrives at the left turn lane, there is already another vehicle that has arrived at that left turn lane or the opposite one, either of which will trigger a “vehicle waiting for green arrow” state). In other cases, it may be possible to predict with certainty that a light will change from “no traffic waiting” to “traffic waiting” because the vehicle itself will trigger the change. Such information can also be used to improve the accuracy of the predictions.

In some embodiments, aspects of the operation of controller 120 that deal specifically with generating notification as to traffic signal state (e.g., red light) duration are handled by a separate notification system controller 120A. Those skilled in the art will recognize that slightly different implementations may be appropriate for various situations and environments, and will determine which of several possible controllers is responsible for such functions. As one example, in some environments where information regarding traffic signal state timing is available directly, notification system controller 120A simply queries the appropriate source of such information (e.g., traffic signals 130 A-N) or a database where this information is stored (e.g., database 129). In other environments, however, there may be no direct source of information regarding timing of traffic signal states; in those instances, the information may be inferred from other available information, for example by storing information over time regarding how long vehicles with user devices such as 110A, 110B are typically stopped by this traffic signal. Given sufficient historical data points, more detailed inferences can be made, such as typical wait times on weekends as opposed to weekdays, at different times of day, and the like. Those skilled in the art will recognize that if information regarding traffic signal state timing is not available directly from the traffic signal (130A) or a related subsystem, best predictions of red light durations will be achieved by taking such detailed issues into account. It also should be noted that implementation of some features described herein requires less than all of the subsystems and modules described above.

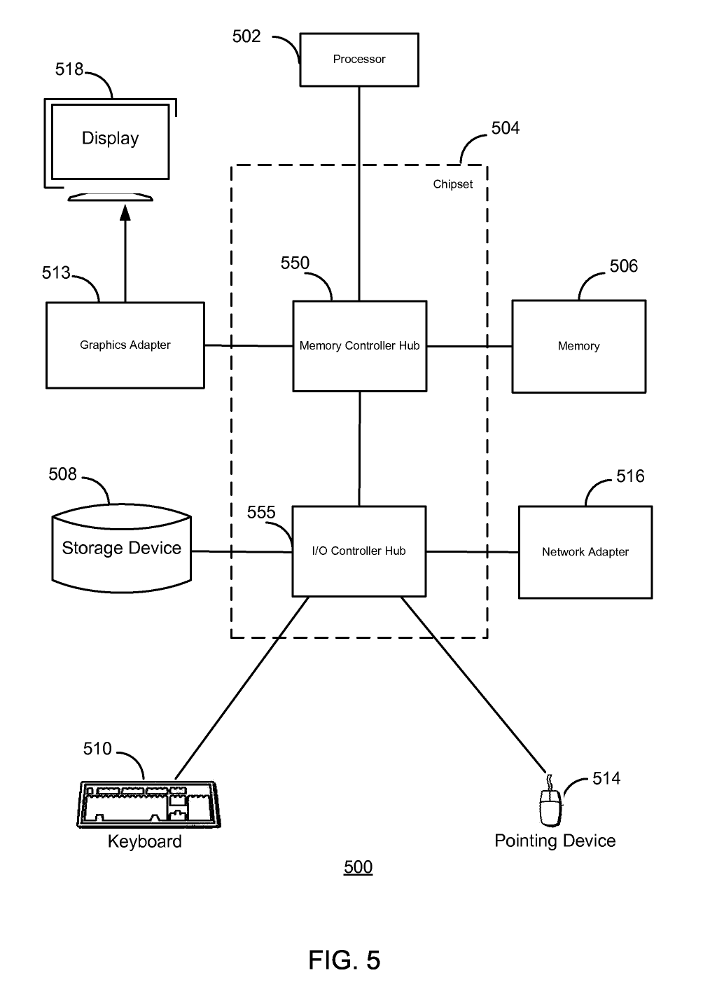

FIG. 5 is high-level block diagram illustrating an example of a computer 500 for use as a user device 110, a controller 120 or a traffic signal 130, in accordance with an embodiment of the system 100. Illustrated are at least one processor 502 coupled to a chipset 504. The chipset 504 includes a memory controller hub 550 and an input/output (I/O) controller hub 555. A memory 506 and a graphics adapter 513 are coupled to the memory controller hub 550, and a display device 518 is coupled to the graphics adapter 513. A storage device 508, keyboard 510, pointing device 514, and network adapter 516 are coupled to the I/O controller hub 555. Other embodiments of the computer 500 have different architectures. For example, the memory 506 is directly coupled to the processor 502 in some embodiments.

The storage device 508 is a computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and in some embodiments is used in combination with the keyboard 510 to input data into the computer system 500. The graphics adapter 513 displays images and other information on the display device 518. In some embodiments, the display device 518 includes a touch screen capability for receiving user input and selections. The network adapter 516 couples the computer system 500 to the network 101. Some embodiments of the computer 500 have different and/or other components than those shown in FIG. 5.

The computer 500 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 508, loaded into the memory 506, and executed by the processor 502.

The types of computers 500 used by the entities of FIG. 1 can vary depending upon the embodiment and the processing power used by the entity. For example, a user device 110 that is a PDA typically has limited processing power, a small display 518, and might lack a pointing device 514. The controller 120, in contrast, may comprise multiple blade servers working together to provide the functionality described herein. As noted above, the portion of data storage and processing performed by each device is preferably based in part on the processing power and available communication bandwidth for each such device.

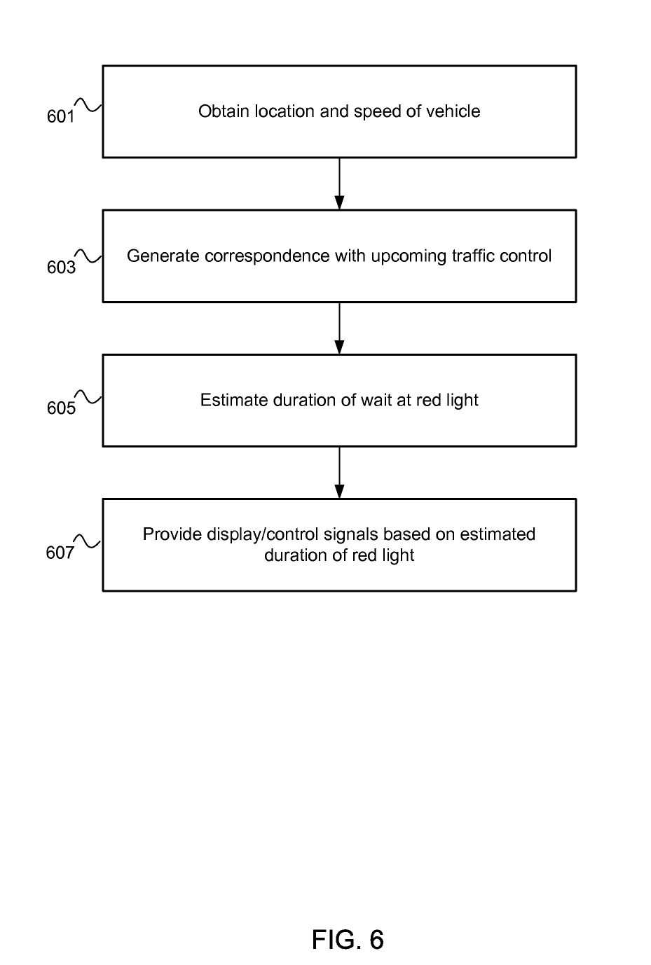

FIG. 6 is a flow chart illustrating a method of providing information regarding the duration of a red light. In step 601, the current location and speed of a vehicle are determined and communicated to controller 120 as described above.

In step 602, a correspondence is generated (i.e., determined) with an upcoming traffic control, e.g., traffic signal 130A. In one embodiment, routing information already provided by the driver is used to predict the next traffic control that the vehicle is expected to encounter; in another embodiment a simple geographical search is made for the next traffic control likely to be encountered based on the vehicle's current location and direction of travel. In one embodiment, a subsystem of controller 120, e.g., routing module 126, is programmed to generate the correspondence.

Once this correspondence is developed, information regarding the location and speed of the vehicle is used to estimate 603 its time of arrival at the traffic control, and information regarding the current and historical states of the traffic control (for example, how long a traffic signal's light stays yellow before turning red) is used to predict the likely state of the traffic control at the time of arrival. If the prediction is that the light will be red, the estimated time that the light will remain red is determined. In one embodiment, this information is updated from time to time, for example as new information becomes available (e.g., a traffic signal reports that someone has requested a pedestrian crossing signal, resulting in an increased duration for the red light). In one embodiment, the estimated time of arrival is generated by routing module 126, and the likely state of the traffic signal at that time is generated by traffic signal interaction module 124.

As noted above, the likely state of the traffic signal may be impacted by the arrival of the vehicle at the traffic signal, or by the arrival of other vehicles at the traffic signal. In such instances, the likely state is updated accordingly.

In step 604, controller 120 sends estimated duration data to user device 110A to allow display for the user of how long the light is expected to remain red. In some embodiments, countdown processing is performed locally on user device 110A, while in others it is performed by controller 120, as discussed further below. Those skilled in the art will recognize that processing may be performed on various devices, with preference for one device or another based on processor capability, communications bandwidth, and the like. Some users will find such information useful in planning actions they may take, or not take, during the duration of the red light. For example, a driver may for energy-saving purposes determine to shut off the vehicle's engine if the wait period is expected to be over one minute. If the expected duration for the red light is short, the driver may decide not to initiate a cell phone call (assuming such activity would be allowed under local law).

In some embodiments, such duration data are not merely for display to the driver, but are used to activate vehicle control measures directly. For example, a duration indication from controller 120 is used in one embodiment as a signal to vehicle control system 140 to automatically turn off the vehicle's engine if the expected remaining red light time is over one minute. In one embodiment, a further visual or audible warning is provided to the driver shortly before the light is expected to turn green again, so that the driver may take corresponding action (e.g., re-start the engine). In other embodiments using the vehicle control system 140 as discussed above, the engine can similarly be re-started automatically in anticipation of the light turning green.

As previously discussed, current or imminent presence of a vehicle at the intersection may change the state of the light, so in some embodiments, the countdown display is updated during countdown, and may accordingly jump from “12 seconds” to “55 seconds” e.g., if a car approaches in an oncoming left turn lane.

In addition to knowing that a vehicle is near an intersection controlled by a traffic signal, other information is usable to determine whether, and for how long, the vehicle will be held at the intersection by a red light. One fundamental issue is the direction of travel of the vehicle; in most situations when one direction of travel is stopped by a red light another direction of travel is enjoying a green light. Thus, direction of travel is used in various embodiments to determine correspondence between a vehicle's travel and the state of a traffic light controlling the vehicle. In many environments, more information is usable to better determine the duration of a red light for a vehicle at an intersection. For instance, if the vehicle is in a left turning lane, the red control may well change earlier, or later, than if the vehicle is in a straight (through) lane. In one embodiment, various techniques, such as those described in the patent applications recited above, are used to establish from GPS readings optionally augmented by historical knowledge of traffic patterns, whether a particular vehicle is in a turning lane or a through lane. In another embodiment, information from a route that is already set in the user device is used as the basis for determining whether a vehicle will be turning or proceeding straight.

To address possible latency issues of network 101, e.g., the Internet, in some embodiments data are provided to local processors, e.g., user device 110A and processing is accomplished locally on that device. In such embodiments, the general allocation of processing and communications is, for example, as follows. First, user device 110A inside a vehicle sends a message to controller 120 with its location, with new location messages being sent from time to time. Controller 120 processes this information and determines that the vehicle may be approaching a traffic light, and thus sends to the vehicle (via the Internet to user device 110A) the location of the traffic light and its status (e.g., light is now green but is expected to turn red in 5.2 seconds and remain red for 78 seconds). The light status information is also refreshed periodically, for instance when the light turns to amber and then again when it turns to red. User device 110A then independently processes this data as described above to determine the expected wait time and to provide a display of same (counting down, for instance, to the time a green light state change is expected). On the other hand, in environments where processing power rather than network delay is the primary constraint, controller 120 may be configured to perform the processing described above instead. Those skilled in the art will recognize that known adaptive distributed processing techniques can be applied to tune such allocation over time to minimize the time needed to generate the duration information.

In a different embodiment, vehicular controls are also applied based on expected remaining red light duration. As previously discussed, an engine off command for energy savings is one application. In another, if a car is equipped with electronically controlled parking brakes and it is determined that the light be red for more than a threshold period of time, user device 110A interacts with the vehicle's control system 140 (either by an existing general purpose connection such as Bluetooth or by direct wired connection) and activates the automatic parking brake to enhance vehicle safety. This feature allows drivers to safely move their feet off the pedals, which may in certain instances be ergonomically desirable.

It should be noted that the discussion above has focused on traffic lights as the traffic controls, but the disclosure here applies to other types of traffic controls as well, such as railroad crossings.

It should also be noted that the systems and methods discussed herein can readily be adapted to other useful functions, thus increasing the value of use of the system. In addition to safety measures and energy efficiency, entertainment features can also be enhanced using these systems and methods. For example, many in-cabin entertainment systems are disabled from use unless the vehicle's parking brake is set; such systems can be automatically enabled through use of the parking brake control discussed above (assuming such operation is in compliance with local vehicle operation laws).

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that various of the process steps and instructions disclosed herein could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A traffic control notification system, comprising:
a vehicle route subsystem configured to determine arrival of a vehicle at a traffic control;
a database configured to store traffic control data;
a traffic control interaction subsystem in operative communication with the database, the traffic control interaction subsystem configured to predict a duration of a particular state of the traffic control, responsive to said arrival of the vehicle at the traffic control; and
a user device interaction subsystem configured to provide a notification to the vehicle responsive to the duration.

2. The notification system of claim 1, further comprising a subsystem configured to determine a correspondence between the vehicle and the traffic control.

3. The notification system of claim 2, wherein the correspondence is determined responsive to location of the traffic control and location and direction of travel of the vehicle.

4. The notification system of claim 2, wherein the correspondence is determined responsive to a route for the vehicle.

5. The notification system of claim 1, wherein the traffic control is a traffic light.

6. The notification system of claim 1, wherein the traffic control is a traffic light and the state is a red light state.

7. The notification system of claim 1, wherein the user device interaction system is further configured to send the notification to a user device for display thereon.

8. The notification system of claim 1, wherein the user device interaction system is further configured to send the notification to a user device for control of the vehicle.

9. The notification system of claim 1, wherein the user device interaction system is further configured to send the notification to the vehicle in order to turn off an engine of the vehicle in response to the duration exceeding a threshold.

10. The notification system of claim 1, wherein the traffic control has a first state corresponding to a red light with no vehicle waiting and a second state corresponding to a red light with a vehicle waiting, and wherein the traffic control interaction subsystem is further configured to predict the duration of the particular state of the traffic control, responsive to transition of the traffic control from the first state to the second state.

11. A non-transitory computer-readable storage medium storing executable computer program code for providing a notification that a vehicle is predicted to remain subject to a traffic control for a period of time, the computer program code comprising instructions for:
determining a location of the vehicle;
establishing correspondence between the vehicle and the traffic control responsive to said determining a location;
predicting a remaining duration of a state of the traffic control; and
providing the notification responsive to the remaining duration.

12. A computer-implemented method for providing a notification that a vehicle is predicted to remain subject to a traffic control for a period of time, the computer-implemented method comprising:
determining a location of the vehicle;
establishing correspondence between the vehicle and the traffic control responsive to said determining a location;
predicting a remaining duration of a state of the traffic control; and
providing the notification responsive to the remaining duration.

13. The computer-implemented method of claim 12, wherein the wherein the correspondence is further established responsive to direction of travel of the vehicle.

14. The computer-implemented method of claim 12, wherein the correspondence is further determined responsive to a route for the vehicle.

15. The computer-implemented method of claim 12, wherein the traffic control is a traffic light.

16. The computer-implemented method of claim 12, wherein the traffic control is a traffic light and the state is a red light state.

17. The computer-implemented method of claim 12, wherein providing the notification includes sending the notification to a user device for display thereon.

18. The computer-implemented method of claim 12, wherein providing the notification includes sending the notification to a user device for control of the vehicle.

19. The computer-implemented method of claim 12, wherein providing the notification includes sending the notification to the vehicle in order to turn off an engine of the vehicle in response to the duration exceeding a threshold.

20. The computer-implemented method of claim 12, wherein the traffic control has a first state corresponding to a red light with no vehicle waiting and a second state corresponding to a red light with a vehicle waiting, and wherein said predicting is further responsive to transition of the traffic control from the first state to the second state.

21. A vehicle management system, comprising:
a vehicle route subsystem configured to determine arrival of a vehicle at a traffic control;
a database configured to store traffic control data;
a traffic control interaction subsystem in operative communication with the database; and
a user device interaction subsystem configured to undertake vehicle management processing responsive to communications with the traffic control interaction subsystem regarding the traffic control being in a vehicle waiting state or a no vehicle waiting state.

22. The vehicle management system of claim 21, wherein the vehicle management processing comprises prediction of a waiting time.

23. The vehicle management system of claim 21, wherein the vehicle management processing comprises determination of a vehicle route.

24. The vehicle management system of claim 21, wherein the traffic control data includes an indication of whether the traffic control is in the vehicle waiting state.

25. The vehicle management system of claim 21, wherein the traffic control interaction subsystem is configured to generate a prediction of a transition from the no vehicle waiting state of the traffic control to the vehicle waiting state of the traffic control.

26. The vehicle management system of claim 25, wherein the prediction is responsive to said arrival of the vehicle at the traffic control.

27. The vehicle management system of claim 25, wherein the prediction is based on real-time data from another vehicle.

28. The vehicle management system of claim 25, wherein the prediction is based on historical observations of vehicle waiting times at the traffic control.

29. A non-transitory computer-readable storage medium storing executable computer program code for vehicle management, the computer program code comprising instructions for:
determining arrival of a vehicle at a traffic control;
determining a transition from a no vehicle waiting state of the traffic control to a vehicle waiting state of the traffic control; and
undertaking vehicle management processing responsive to the transition.

30. The non-transitory computer-readable storage medium of claim 29, wherein the vehicle management processing comprises prediction of a waiting time.

31. The non-transitory computer-readable storage medium of claim 29, wherein the vehicle management processing comprises determination of a vehicle route.

32. The non-transitory computer-readable storage medium of claim 29, wherein said determining a transition further comprises obtaining traffic control data regarding whether the traffic control is in the vehicle waiting state.

33. The non-transitory computer-readable storage medium of claim 29, wherein said determining a transition comprises generating a prediction of the transition.

34. The non-transitory computer-readable storage medium of claim 33, wherein the prediction is responsive to said arrival of the vehicle at the traffic control.

35. The non-transitory computer-readable storage medium of claim 33, wherein the prediction is based on real-time data from another vehicle.

36. The non-transitory computer-readable storage medium of claim 33, wherein the prediction is based on historical observations of vehicle waiting times at the traffic control.

37. A computer-implemented method for managing a traffic control, the computer-implemented method comprising:
determining arrival of a vehicle at a traffic control;
determining a transition from a no vehicle waiting state of the traffic control to a vehicle waiting state of the traffic control; and
undertaking vehicle management processing responsive to the transition.

38. The computer-implemented method of claim 37, wherein the vehicle management processing comprises prediction of a waiting time.

39. The computer-implemented method of claim 37, wherein the vehicle management processing comprises determination of a vehicle route.

40. The computer-implemented method of claim 37, wherein said determining a transition further comprises obtaining traffic control data regarding whether the traffic control is in the vehicle waiting state.

41. The computer-implemented method of claim 37, wherein said determining a transition comprises generating a prediction of the transition.

42. The computer-implemented method of claim 41, wherein the prediction is responsive to said arrival of the vehicle at the traffic control.

43. The computer-implemented method of claim 41, wherein the prediction is based on real-time data from another vehicle.

44. The computer-implemented method of claim 41, wherein the prediction is based on historical observations of vehicle waiting times at the traffic control.
